(19) United States
(12) Patent Application Publication
(10) Pub. No.: US 2014/0320341 A1
(43) Pub. Date: Oct. 30, 2014

(54) POSITION CALCULATING METHOD AND POSITION CALCULATING DEVICE

(71) Applicant: Seiko Epson Corporation, Tokyo (JP)

(72) Inventor: Kiyotaka MURAKI, Shiojiri (JP)

(73) Assignee: Seiko Epson Corporation, Tokyo (JP)

(21) Appl. No.: 14/159,091

(22) Filed: Jan. 20, 2014

(30) Foreign Application Priority Data
Jan. 23, 2013 (JP) 2013-009914

(51) Int. Cl. G01S 19/13

(52) U.S. Cl. CPC G01S 19/13
USPC 342/357.51

(57) ABSTRACT

A position calculating method includes receiving positioning information including at least earth orientation information from a positioning satellite that transmits the positioning information, calculating orbit information of the positioning satellite using the positioning information, and calculating a position of a receiver using a signal from the positioning satellite and the orbit information.

This application claims priority to Japanese Patent Application No. 2013-009914, filed Jan. 23, 2013, the entirety of which is hereby incorporated by reference.

### BACKGROUND

1. Technical Field

The present invention relates to a position calculating method and a position calculating device.

2. Related Art

A global positioning system (GPS) is widely known as a position calculating system using a positioning signal from a positioning satellite and as a position calculating device, is built into a mobile phone, a car navigation apparatus, or the like. In the GPS, orbit information (ephemeris or almanac) loaded onto GPS satellite signals is acquired to specify a position of a satellite and then the position of the device is calculated on the basis of a pseudo-distance.

When initially calculating a position, the ephemeris is not held and thus the ephemeris first needs to be acquired. However, since several tens of seconds is necessary for acquiring the ephemeris, the time to first fix (TTFF) increases.

Therefore, a method of predicting trajectories of GPS satellites and calculating satellite orbit information corresponding to the ephemeris is used to shorten the TIFF. Here, since an earth orientation parameter (EOP) is required for calculating the satellite orbit information, Mari et al. have proposed a technique of estimating the earth orientation parameter from the ephemeris.

Mari Seppanen, Tommi Perala, and Robert Piche, Tampere University of Technology, Finland, Autonomous Satellite Orbit Prediction International Technical Meeting of The Institute of Navigation, San Diego, Calif., Jan. 24-26, 2011.

However, in the technique proposed by Mari et al., a computational load for estimating the earth orientation parameter (EOP) from the ephemeris is large. Accordingly, power consumption for calculating the orbit information of the GPS satellites increases.

### SUMMARY

An advantage of some aspects of the invention is to calculate orbit information with reduced power consumption.

### APPLICATION EXAMPLE 1

This application example is directed to a position calculating method including: receiving positioning information including at least earth orientation information from a positioning satellite that transmits the positioning information; calculating orbit information of the positioning satellite using the positioning information; and calculating a position of a receiver using a signal from the positioning satellite and the orbit information.

According to this application example, since the earth orientation parameter (EOP) is not estimated from the ephemeris, it is possible to reduce power consumption for acquiring the earth orientation parameter (EOP). Accordingly, it is possible to calculate orbit information with reduced power consumption.

### APPLICATION EXAMPLE 2

In the position calculating method according to the application example, it is preferable that the calculating of the orbit information includes calculating the orbit information using a motion equation expressing a motion of a satellite moving around the earth and the position and the velocity of the positioning satellite.

According to this application example, since orbit information of a positioning satellite can be calculated, it is possible to shorten the time to first fix in the position calculation based on the signal from the positioning satellite.

### APPLICATION EXAMPLE 3

In the position calculating method according to the application example, it is preferable that the position and the velocity of the positioning satellite are the position and the velocity of the positioning satellite at a predetermined single time.

According to this application example, the position and the velocity of the positioning satellite used to calculate the orbit information are a set of position and velocity. Accordingly, it is possible to reduce an amount of memory for storing information on the position and the velocity of the positioning satellite.

### APPLICATION EXAMPLE 4

In the position calculating method according to the application example, it is preferable that the motion equation is defined in an inertial coordinate system based on the earth center, the position and the velocity of the positioning satellite are defined in a fixed coordinate system based on the earth center, and the calculating of the orbit information includes transforming the position and the velocity of the positioning satellite into a position and a velocity in the inertial coordinate system using the earth orientation information included in the positioning information.

According to this application example, the position and the velocity of the positioning satellite defined in the fixed coordinate system are transformed to the inertial coordinate system which is a coordinate system of the motion equation using the earth orientation information included in the positioning information. Accordingly, it is possible to calculate the orbit information of the positioning satellite from the position and the velocity of the positioning satellite.

### APPLICATION EXAMPLE 5

In the position calculating method according to the application example, it is preferable that the calculating of the orbit information includes calculating an ephemeris parameter of the positioning satellite.

According to this application example, the calculated orbit information is an ephemeris parameter. Accordingly, as long as it is a device that can calculate a position using the ephemeris of the positioning satellite, the device can be used to calculate a position without converting the calculated orbit information into another format.

### APPLICATION EXAMPLE 6

This application example is directed to a position calculating device including: a receiver unit that receives positioning information including at least earth orientation information from a positioning satellite that transmits the positioning information; an orbit information calculating unit that calculates orbit information of the positioning satellite using the positioning information; and a position calculating unit that calculates a position using a signal from the positioning satellite and the orbit information.

According to this application example, since the earth orientation parameter (EOP) is not estimated from the ephemeris, it is possible to reduce power consumption for acquiring the earth orientation parameter (EOP). Accordingly, it is possible to calculate orbit information with reduced power consumption.

### BRIEF DESCRIPTION OF THE DRAWINGS

The invention will be described with reference to the accompanying drawings, wherein like numbers reference like elements.

FIG. 1 is a diagram illustrating a configuration of a position calculating device according to an exemplary embodiment.

FIG. 2 is a diagram illustrating a functional configuration of a baseband processing circuit unit.

FIG. 3 is a flowchart illustrating a flow of a baseband process.

FIG. 4 is a flowchart illustrating a modification example of the baseband process.

### DESCRIPTION OF EXEMPLARY EMBODIMENTS

Hereinafter, an exemplary embodiment of the invention will be described with reference to the accompanying drawings. However, an applicable embodiment of the invention is not limited to the exemplary embodiment.

### Outline

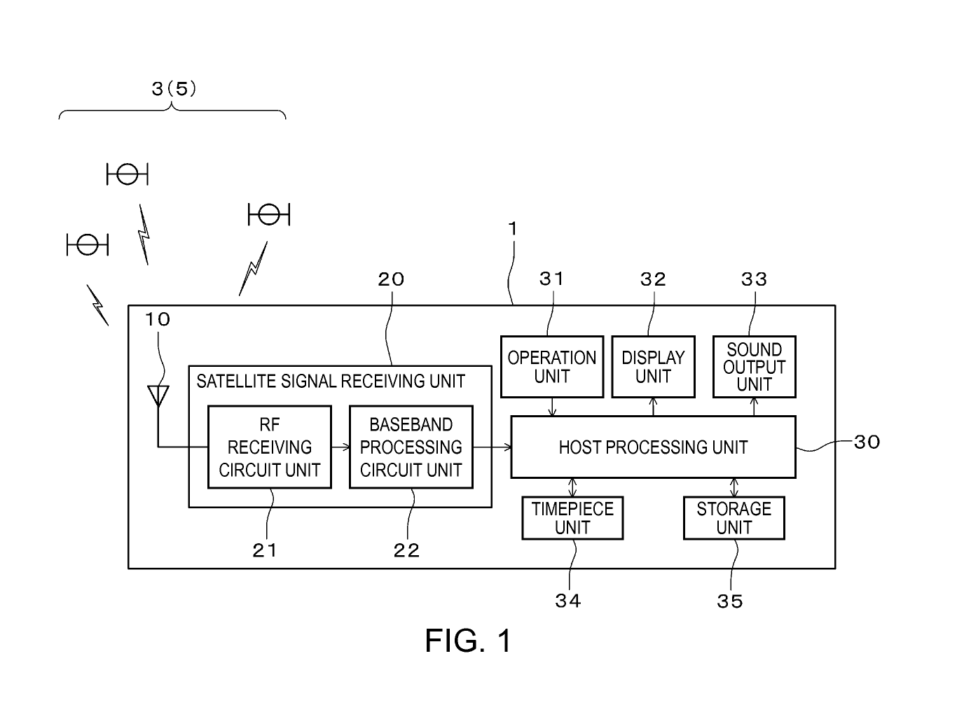

FIG. 1 is a diagram illustrating a configuration of a position calculating device 1 according to an exemplary embodiment. The position calculating device 1 is a receiver unit that receives satellite signals from a GPS satellite (capturing target satellite) 3 and from GPS satellites (positioning satellites) 5 and calculates a position of the device on the basis of the received satellite signals.

In this exemplary embodiment, it is assumed that the positioning satellite 5 emits an L1C signal (positioning satellite signal) of a next-generation civil GPS signal newly added to the same 1575.42 MHz band as an L1C/A signal in accordance with the US GPS modernization program. In this embodiment, it is assumed that the positioning satellite 5 emits positioning information which is information for supporting the GPS positioning as a piece of navigation data (CNAV2) loaded onto an L1C signal. The positioning information includes satellite position and velocity information and an earth orientation parameter (EOP) which is earth orientation information. The satellite position and velocity information includes a position r₀ and a velocity v₀ at a certain time t₀ and a clock error of each capturing target satellite 3. The earth orientation parameter (EOP) includes UT1-UTC, a length of day (LOD), X polar motion, X polar motion rate, Y polar motion, and Y polar motion rate.

When initially calculating a position (performing an initial positioning process), the position calculating device 1 estimates an ephemeris (orbit information) of a capturing target satellite 3 using the positioning information received from the positioning satellite 5 and calculates the position (performs a positioning process) using the estimated ephemeris. When GPS satellite signals are successively received from the capturing target satellites 3 after initially calculating the position and the ephemeris included in the GPS satellite signals is finally acquired, the process is switched to calculating of a position using the acquired ephemeris. In this way, by using the positioning information from the positioning satellite 5, shortening of the time to first fix (TTFF) is realized.

### Principle

Estimation of an ephemeris of a capturing target satellite 3 based on the positioning information received from the positioning satellite 5 will be described below.

First, a motion equation of Expression (1) is established for a capturing target satellite 3.

$$\begin{matrix}\ddot{r} = \frac{F}{m} \\ = a ( t , r )\end{matrix} \qquad ( 1 )$$

In Expression (1), m represents a mass of the capturing target satellite 3, F represents a force acting on the capturing target satellite 3, and r represents a position of the capturing target satellite 3 at time t. In addition, a represents an acceleration acting on the capturing target satellite 3 and is expressed by Expression (2).

a(t, r)=a_{g}+aₘₒₒₙ+aₛᵤₙ+a_{srg} (2)

In Expression (2), a_{g} represents a gravitational acceleration, aₘₒₒₙ represents the gravitation of the moon, aₛᵤₙ represents the gravitation of the sun, and a_{srg} represents the solar radiation pressure. That is, the motion equation expressing the motion of a satellite moving around the earth in the cosmic space is determined by Expressions (1) and (2).

By numerically integrating the motion equation of Expression (1) with a position r(t₀)=r₀ and a velocity v(t₀)=v₀ at time t₀ as initial values, an orbital function indicating the position r(t) of the capturing target satellite 3 at time t, that is, an orbit function indicating a satellite orbit, is obtained as Expression (3).

r(t)=r₀+∫ₜ_{₀}^{t}(v₀+∫ₜ_{₀}^{t}a(t,r)dt)dt (3)

Here, the given initial values are set to the position r₀ and the velocity v₀ of the capturing target satellite 3 at time t₀, which are included in the positioning information. When the satellite orbit is calculated, the ephemeris suitable for the satellite orbit can be estimated.

The motion equation (Expression (1)) indicating a motion of a satellite is defined in an earth-centered inertial (ECI) coordinate system which is an inertial coordinate system based on the earth center. On the other hand, the position calculated by the position calculating device 1 or the position and the velocity of the capturing target satellite 3 included in the positioning information emitted from the positioning satellite 5 are defined in an earth-centered earth fixed (ECEF) coordinate system which is a coordinate system fixed to the earth on the basis of the earth center.

Accordingly, coordinate transformation between the earth-centered inertial (ECI) coordinate system and the earth-centered earth fixed (ECEF) coordinate system is required for estimation of a satellite orbit. A coordinate transform matrix Q between the earth-centered inertial (ECI) coordinate system and the earth-centered earth fixed (ECEF) coordinate system is expressed by Expression (4) as widely known.

R_{ECEF}=QR_{ECI}

Q=[A][B][C][D] (4)

In Expression (4), A represents a rotation matrix of polar motion, B represents a rotation matrix of sidereal time, C represents a rotation matrix of nutation, and D represents a rotation matrix of precession. The matrices A, B, C, and D are determined by time t and the earth orientation parameter (EOP) included in the positioning information. In other words, it can also be said that the matrices A, B, C, and D are expressed and the coordinate transform matrix Q is determined by the earth orientation parameter (EOP).

### Configuration of Positioning Device

The position calculating device 1 includes a satellite receiving antenna 10, a satellite signal receiving unit (receiver unit) 20, a host processing unit 30, an operation unit 31, a display unit 32, a sound output unit 33, a timepiece unit 34, and a storage unit 35.

The satellite receiving antenna 10 is an antenna that receives a radio frequency (RF) signal including GPS satellite signals emitted from the capturing target satellites 3 or the positioning satellite signal (QZS satellite signal) emitted from the positioning satellite 5.

The satellite signal receiving unit 20 includes an RF receiving circuit unit 21 and a baseband processing circuit unit 22 and calculates the position of the position calculating device 1 on the basis of the satellite signals received through the use of the satellite receiving antenna 10. The RF receiving circuit unit 21 and the baseband processing circuit unit 22 may be manufactured as independent large scale integration (LSI) chips or may be manufactured in a single chip.

The RF receiving circuit unit 21 is a circuit that receives an RF signal. For example, the circuit may have a configuration of a receiver circuit that converts an RF signal received through the use of the satellite receiving antenna 10 into a digital signal by the use of an A/D converter and processes the digital signal, or may have a configuration that processes an RF signal received through the use of the satellite receiving antenna 10 as an analog signal, finally A/D-converts the analog signal, and outputs the converted digital signal to the baseband processing circuit unit 22.

In the latter, for example, the RF receiving circuit unit 21 may be configured as follows. That is, an oscillation signal for RF signal multiplication is generated by dividing or multiplying a predetermined oscillation signal. The RF signal is down-converted into an intermediate frequency (IF) signal by multiplying the generated oscillation signal by the RF signal output from the satellite receiving antenna 10, the IF signal is subjected to amplification or the like, and the resultant IF signal is converted into a digital signal through the use of the A/D converter, and the digital signal is output to the baseband processing circuit unit 22.

The baseband processing circuit unit 22 performs a carrier removing process or a correlation process on the signal received by the RF receiving circuit unit 21 and captures a GPS satellite signal or a positioning satellite signal. A predetermined position calculating process based on the ephemeris extracted from the captured GPS satellite signal or the positioning information extracted from the captured positioning satellite signal is performed to calculate the position (position coordinates) or the clock error of the position calculating device 1.

The host processing unit 30 is embodied by a computing device such as a CPU and comprehensively controls the units of the position calculating device 1 in accordance with various programs such as a system program stored in the storage unit 35. For example, a map indicating a current position is displayed on the display unit 32 or the position coordinates are used for various application processes on the basis of the position coordinates acquired from the baseband processing circuit unit 22.

The operation unit 31 is an input device such as a touch panel or button switches and outputs an operation signal corresponding to the performed operation to the host processing unit 30. Various instructions such as a position calculation request are input by the operation of the operation unit 31.

The display unit 32 is a display device such as an LCD and performs various displays based on a display signal input from the host processing unit 30. The sound output unit 33 is a sound output device such as a speaker and outputs various sounds based on a sound signal input from the host processing unit 30. The timepiece unit 34 is an internal timepiece and includes an oscillation circuit such as a crystal oscillator.

The storage unit 35 is embodied by a storage device such as a ROM or a RAM and stores a system program for causing the host processing unit 30 to comprehensively control the position calculating device 1 or various programs or data for performing various application processes.

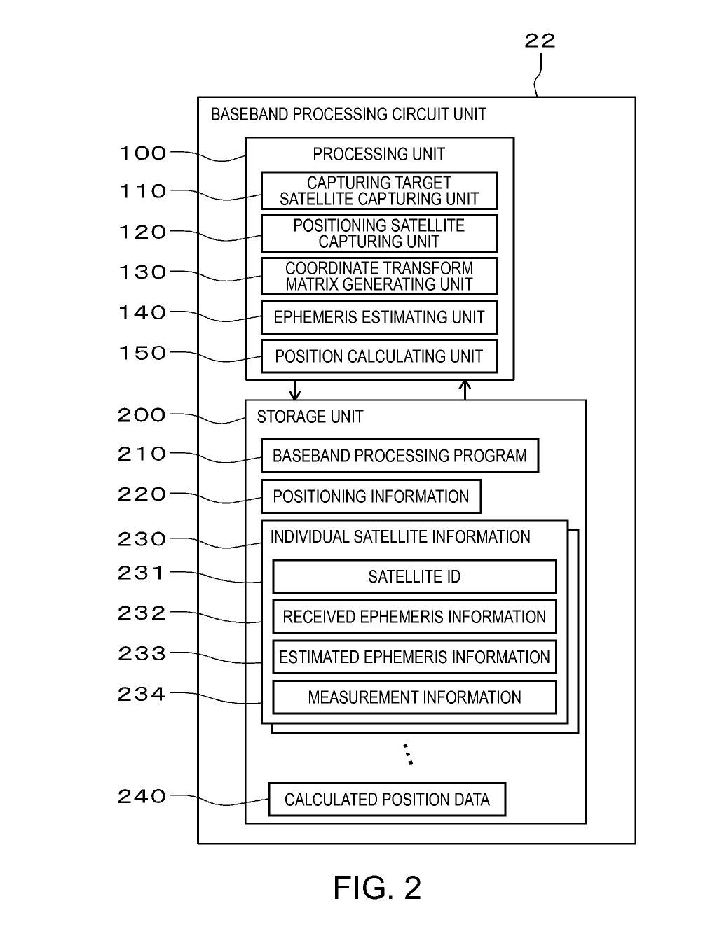

FIG. 2 is a diagram illustrating a functional configuration of the baseband processing circuit unit 22. The baseband processing circuit unit 22 includes a processing unit 100 and a storage unit 200.

The processing unit 100 is embodied by a computing device such as a CPU or a DSP and controls the entire baseband processing circuit unit 22 on the basis of the programs or the data stored in the storage unit 200. The processing unit 100 includes a capturing target satellite capturing unit 110, a positioning satellite capturing unit 120, a coordinate transform matrix generating unit 130, an ephemeris estimating unit (orbit information calculating unit) 140, and a position calculating unit 150.

The capturing target satellite capturing unit 110 captures a GPS satellite signal. First, a capturing target satellite 3 to be captured is selected. Specifically, a capturing target satellite 3 located at a predetermined reference position in the sky at the current time counted by the timepiece unit 34 is determined using the almanac acquired in advance, long-term predicted orbit data, or the like and is set as the capturing target satellite 3. The reference position is set to a position acquired by server assistance, for example, when a position is initially calculated after powering on, and the reference position is set to the latest calculated position when a position is calculated secondly or subsequently thereto.

Subsequently, a GPS satellite signal of each capturing target satellite 3 is captured. That is, a capturing target satellite 3 is captured by performing a correlation calculation using a replica C/A code corresponding to the capturing target satellite 3 on the received signal output from the RF receiving circuit unit 21. Then, a carrier is removed from the captured GPS satellite signal, the navigation message included in the GPS satellite signal is decoded, and the ephemeris included in the navigation message is acquired. The acquired ephemeris is stored as received ephemeris information 232 of the capturing target satellite 3 in the storage unit 200.

The positioning satellite capturing unit 120 captures a positioning satellite signal. That is, similarly to the capturing of the capturing target satellite 3 by the capturing target satellite capturing unit 110, a positioning satellite 5 is captured by performing a correlation calculation using a replica C/A code corresponding to the positioning satellite 5 to be captured on the received signal output from the RF receiving circuit unit 21. Then, a carrier is removed from the captured positioning satellite signal and the positioning information included in the positioning satellite signal is decoded. The acquired positioning information is stored as positioning information 220 in the storage unit 200.

The coordinate transform matrix generating unit 130 calculates a coordinate transform matrix Q between the earth-centered inertial (ECI) coordinate system and the earth-centered earth fixed (ECEF) coordinate system defined in Expression (4) using the earth orientation parameter (EOP) included in the positioning information 220.

The ephemeris estimating unit 140 estimates the ephemeris of each capturing target satellite 3 on the basis of the positioning information 220. Specifically, the position r₀ and the velocity v₀ of the capturing target satellite 3 included in the positioning information 220 are transformed from the earth-centered earth fixed (ECEF) coordinate system to the earth-centered inertial (ECI) coordinate system using the coordinate transform matrix Q generated by the coordinate transform matrix generating unit 130. Subsequently, an orbital function r(t) indicating a satellite orbit is calculated by numerically integrating the orbital function r(t) of Expression (3) with the position r₀ and the velocity v₀ after the coordinate transformation as initial values. The ephemeris suitable for the satellite orbit expressed by the orbital function r(t) is calculated. The ephemeris can be calculated using a numerical calculation method (for example, a least squares method) of minimizing a difference between the satellite orbit based on the regular ephemeris parameter value and the satellite orbit indicated by the orbital function r(t). Here, other methods may be used. The calculated ephemeris is stored as estimated ephemeris information 233 of the capturing target satellite 3 in the storage unit 200.

The position calculating unit 150 calculates the position of the position calculating device 1. Specifically, as initial position calculation after being powered on, the position is calculated using the estimated ephemeris information 233 of each capturing target satellite 3 to be captured. Thereafter, when the ephemeris of all the capturing target satellites 3 to be captured is acquired by successively receiving GPS satellite signals, the position is calculated using the received ephemeris information 232. The calculated positions are cumulatively stored as calculated position data 240 in the storage unit 200, for example, in correlation with calculation times thereof.

The storage unit 200 is embodied by a storage device such as a ROM or a RAM, stores a system program for causing the processing unit 100 to comprehensively control the baseband processing circuit unit 22 or programs, data or the like for performing various functions, serves as a work area of the processing unit 100, and temporarily stores the result of the calculation which is performed by the processing unit 100 in accordance with various programs. In this embodiment, a baseband processing program 210, positioning information 220, individual satellite information 230, and calculated position data 240 are stored therein.

The individual satellite information 230 is generated for each capturing target satellite 3 and includes a satellite ID 231 for identifying the corresponding capturing target satellite 3, the received ephemeris information 232, the estimated ephemeris information 233, and measurement information 234.

### Process Flow

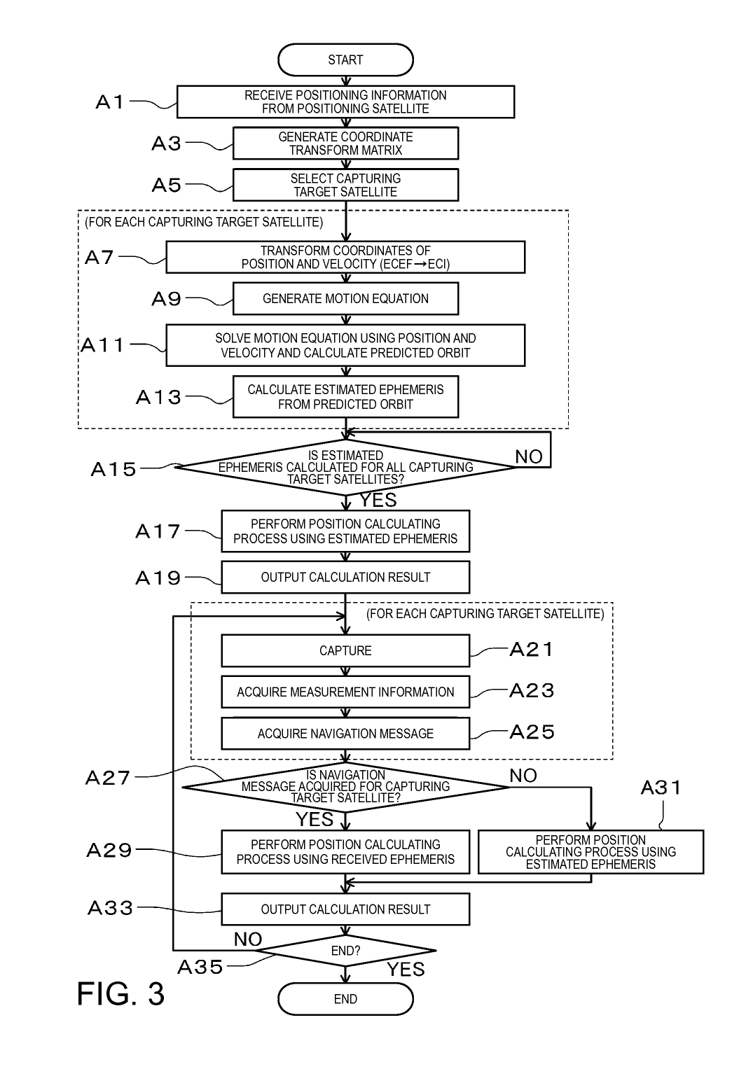

FIG. 3 is a flowchart illustrating a flow of a baseband process. This process is a process which is performed by causing the processing unit 100 to execute the baseband processing program 210.

First, in step A1, the positioning satellite capturing unit 120 captures a positioning satellite signal and acquires positioning information 220 included in the captured positioning satellite signal. Then, in step A3, the coordinate transform matrix generating unit 130 generates a coordinate transform matrix Q between the earth-centered inertial (ECI) coordinate system and the earth-centered earth fixed (ECEF) coordinate system using the acquired earth orientation parameter (EOP). Subsequently, in step A5, the capturing target satellite capturing unit 110 selects a capturing target satellite 3 to be captured.

Then, the ephemeris estimating unit 140 performs an orbit estimating process on the selected capturing target satellites 3 in parallel. In the orbit estimating process, first, in step A7, coordinates of the position r₀ and the velocity v₀ of the corresponding capturing target satellite 3 included in the acquired positioning information 220 are transformed using the coordinate transform matrix Q. Subsequently, a motion equation for the capturing target satellite 3 is generated in step A9, and a predicted satellite orbit of the capturing target satellite 3 is calculated by numerically integrating the motion equation with the position r₀ and the velocity v₀ as the initial values after the coordinate transformation in step A11. Then, in step A13, the estimated ephemeris is calculated from the predicted satellite orbit.

When the estimated ephemeris is calculated for all the capturing target satellites 3 (YES in step A15), a position calculating operation using the estimated ephemeris is performed to calculate the position of the position calculating device 1 in step A17. Specifically, the position of the capturing target satellite 3 to be captured is specified using the estimated ephemeris and the current position of the position calculating device 1 is calculated from the specified satellite position and a pseudo-distance based on the received GPS satellite signal. Then, in step A19, for example, the calculated position is output to and displayed on the display unit 32.

Subsequently, in step A21, capturing processes for the capturing target satellites 3 are performed in parallel. In the capturing process, the corresponding GPS satellite signal is captured. Then, the measurement information (code phase and receiving frequency) 234 of the captured capturing target satellite 3 is acquired in step A23 and the navigation message is decoded in step A25.

When a navigation message of the capturing target satellite 3 is acquired (YES in step A27), a position calculating operation using the ephemeris included in the acquired navigation message is performed to calculate the position of the position calculating device 1 in step A29. On the other hand, when the navigation message is not acquired (NO in step A27), a position calculating operation using the estimated ephemeris is performed in step A31. Then, in step A33, for example, the calculated position is output to and displayed on the display unit 32.

Thereafter, the processing unit 100 determines whether the process flow should end, and performs the process of step A21 again when it is determined that the process flow should not end (NO in step A35). When it is determined that the process flow should end (YES in step A35), the baseband process ends.

### Operational Advantages

In this way, the position calculating device 1 according to this exemplary embodiment acquires the earth orientation parameter (EOP) included in the navigation data (CNAV2) of an L1C signal which is a next-generation civil GPS signal and uses the acquired EOP to generate the ephemeris. Accordingly, since the earth orientation parameter (EOP) is equal to the accurate value provided by the international earth rotation service (IERA), it is possible to more accurately perform coordinate transformation (ECEF⇄ECI) necessary for prediction of a satellite orbit by using the accurate earth orientation parameter (EOP) included in the L1C. When the accurate coordinate transformation is possible, it is possible to accurately predict an orbit and to improve accuracy of the ephemeris which is finally generated. Since the earth orientation parameter (EOP) is acquired from the L1C, unnecessary calculating operations do not have to be performed and it is thus possible to further reduce power consumption.

### MODIFICATION EXAMPLES

An applicable embodiment of the invention is not limited to the above-mentioned exemplary embodiment, but can be appropriately modified without departing from the concept of the invention.

### (A) Calculation of Position of Capturing Target Satellite

In the above-mentioned exemplary embodiment, the satellite orbit (orbit function r(t)) of a capturing target satellite 3 is acquired from the positioning information 220 and the ephemeris representing the satellite orbit is estimated. However, the position of the capturing target satellite 3 may be directly acquired from the satellite orbit (orbit function r(t)) and a position may be calculated using the acquired satellite position.

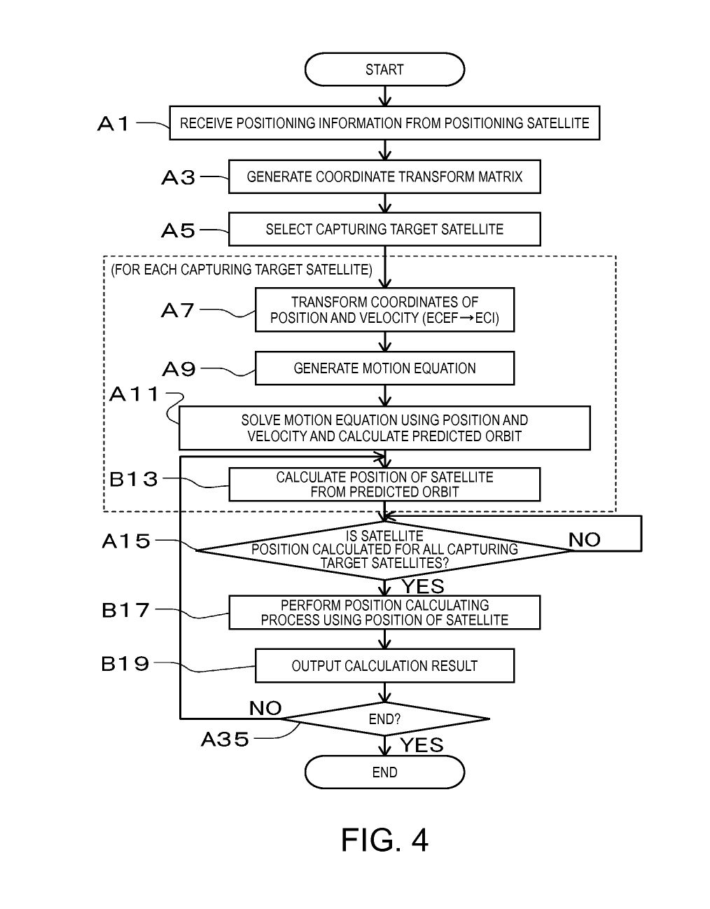

Specifically, when the predicted satellite orbit (that is, the orbit function r(t) representing the satellite orbit in step A11) of a capturing target satellite 3 is calculated as shown in FIG. 4, the position of the capturing target satellite 3 at a predetermined time t is calculated from the predicted orbit in step B13. When the satellite position is calculated for all the capturing target satellites 3 (YES in step A15), the position calculation using the satellite positions is performed to calculate the position of the position calculating device 1 at a predetermined time t in step B17. Then, in step B19, for example, the calculated position is output to and displayed on the display unit 32. Thereafter, the processing unit 100 determines whether the process flow should end. When it is determined that the process flow should not end (NO in step A35), the process flow returns to step B13. When it is determined that the process flow should end (YES in step A35), the baseband process ends.

According to this modification example, it is not necessary to calculate the estimated ephemeris from the predicted orbit or to successively receive GPS satellite signals to acquire the ephemeris.

### (B) Positioning Information

In the above-mentioned exemplary embodiment, for example, the positioning information 220 includes a piece of position information and a piece of velocity information of the position r₀ and the velocity v₀ at a certain time t₀, but may include position information and velocity information at plural time.

In the above-mentioned exemplary embodiment, the positioning information 220 includes the satellite position and velocity information of a capturing target satellite 3. However, the positioning information 220 may include satellite position and velocity information of a positioning satellite 5. In this case, the position calculating device 1 can receive the positioning information 220 including the satellite position and velocity information of the positioning satellite 5 from the positioning satellite 5, predict the satellite orbit of the positioning satellite 5 using the positioning information 220, and perform the position calculation using the ephemeris estimated from the predicted satellite orbit.

In the above-mentioned exemplary embodiment, the positioning information 220 includes the satellite position and velocity information. However, the positioning information 220 may not include the satellite position and velocity information. In this case, the position calculating device 1 calculates satellite position and velocity information from the ephemeris or acquires the satellite position and velocity information from an external information provider.

(C) Satellite Positioning System

In the above-mentioned exemplary embodiment, the position calculating device that acquires the ephemeris of a capturing target satellite 3 and performs the position calculation is exemplified, but other satellite positioning systems such as, WAAS (Wide Area Augmentation System), GLONASS (GLObal NAvigation Satellite System), and GALILEO may be employed.

What is claimed is:

1. A position calculating method comprising:
receiving positioning information including at least earth orientation information from a positioning satellite that transmits the positioning information;
calculating orbit information of the positioning satellite using the positioning information; and
calculating a position of a receiver using a signal from the positioning satellite and the orbit information.

2. The position calculating method according to claim 1, wherein the calculating of the orbit information includes calculating the orbit information using a motion equation expressing a motion of a satellite moving around the earth and the position and the velocity of the positioning satellite.

3. The position calculating method according to claim 2, wherein the position and the velocity of the positioning satellite are the position and the velocity of the positioning satellite at a predetermined single time.

4. The position calculating method according to claim 3, wherein the motion equation is defined in an inertial coordinate system based on the earth center,
wherein the position and the velocity of the positioning satellite are defined in a fixed coordinate system based on the earth center, and
wherein the calculating of the orbit information includes transforming the position and the velocity of the positioning satellite into a position and a velocity in the inertial coordinate system using the earth orientation information included in the positioning information.

5. The position calculating method according to claim 1, wherein the calculating of the orbit information includes calculating an ephemeris parameter of the positioning satellite.

6. A position calculating device comprising:
a receiver unit that receives positioning information including at least earth orientation information from a positioning satellite that transmits the positioning information;
an orbit information calculating unit that calculates orbit information of the positioning satellite using the positioning information; and
a position calculating unit that calculates a position using a signal from the positioning satellite and the orbit information.
